(19) United States
(12) Patent Application Publication
(10) Pub. No.: US 2016/0337761 A1
(43) Pub. Date: Nov. 17, 2016

(54) SURFACE MICROMACHINED MICROPHONE WITH BROADBAND SIGNAL DETECTION

(71) Applicant: BOARD OF REGENTS, THE UNIVERSITY OF TEXAS SYSTEM, Austin, TX (US)

(72) Inventors: Neal A. Hall, Austin, TX (US); Michael L. Kuntzman, Itasca, IL (US); Karen Kirk Sauceda, Apopka, FL (US)

(21) Appl. No.: 15/111,080

(22) PCT Filed: Jan. 12, 2015
(86) PCT No.: PCT/US15/10997

§ 371 Date: Jul. 12, 2016

Related U.S. Application Data
(60) Provisional application No. 61/926,868, filed on Jan. 13, 2014.

(51) Int. Cl. H04R 17/02

(52) U.S. Cl. CPC H04R 17/02

(57) ABSTRACT

A surface micromachined microphone with a 230 kHz bandwidth. The structure uses a 2.25 μm thick, 305 μm radius polysilicon diaphragm suspended above an 11 μm gap to form a variable parallel-plate capacitance. The backcavity of the microphone consists of the 11 μm thick air volume immediately behind the moving diaphragm, and also an extended larger cavity with a radius of 504 μm. The dynamic frequency response of the sensor in response to electrostatic signals is presented using laser Doppler vibrometry, and indicates a system compliance of 0.4 nm/Pa in the flat-band of the response. The sensor is configured for acoustic signal detection using a charge amplifier configuration, and signal to noise ratio measurements and simulations are presented herein. A resolution of 0.80 mPa/√Hz (32 dB SPL in a 1 Hz bin) is achieved in the flat-band portion of the response extending from 10 kHz to 230 kHz.

### CROSS REFERENCE TO RELATED APPLICATIONS

This application claims priority to U.S. Provisional Patent Application Ser. No. 61/926,868, “Surface-Micromachined Microphone,” filed Jan. 13, 2014, which is incorporated by reference herein in its entirety.

### GOVERNMENT INTERESTS

The U.S. Government has certain rights in this invention pursuant to the terms of the Defense Advanced Research Projects Agency Grant No. N66001-12-1-4222.

### TECHNICAL FIELD

The present invention relates generally to microphones, and more particularly to a surface micromachined microphone with broadband signal detection.

### BACKGROUND

A microphone is a pressure sensor designed to sense very small pressure oscillations across the audio frequency range (20 Hz-20 kHz). Typically, a compliant diaphragm is designed to deflect in proportion to sound pressure. The deflection is, in-turned, measured in a number of ways (capacitively, optically, or piezoelectrically) to ultimately produce an output voltage in proportion to the sound pressure.

Microphones with bandwidth extending beyond audio range and up to hundreds of kHz and beyond have applications in several fields. In aeroacoustics, measurements with broadband microphone arrays and dynamic pressure sensors are used to study sources of noise of various aircraft components and to study turbulent boundary layers. Acoustic cameras utilizing nearfield holography techniques have been developed to study noise sources in many industrial noise control applications including the automotive and manufacturing sectors. Broadband acoustic sensors are also applied in military and defense applications, for example, in acoustic fingerprinting applications and sniper detection systems where muzzle blasts with spectral content up to 1 MHz is measured. Additionally, broadband acoustic sensors are utilized in niche scientific applications. One example is from the field of biology in which small, broadband microphones were mounted atop bats to measure echolocation pulse intensity.

Currently, such broadband measurement microphones are either macro-scale broadband measurement microphones or broadband microelectromechanical systems (MEMS) microphones. Such broadband measurement microphones need to be manufactured small in size since the wavelengths of sound become small at high frequency. Typical commercially available microphones of macro-scaled broadband microphones are ⅛″ diameter, have bandwidth extending to approximately 140 kHz, noise floors of approximately 52 dB_{SPL}, and cost several thousand dollars. MEMS microphones designed for high-frequency applications typically have noise floors ranging from 39-70 dB_{SPL} and bandwidth extending as high as 100-140 kHz.

A disadvantage of both macro-scale and micromachined broadband measurement microphones is fabrication complexity. Both the macro and micromachined versions require a compliant membrane suspended over a perforated backplate. Both the membrane and backplate are conductive, forming a variable capacitor, with a value that modulates when the membrane moves in response to sound pressure. Both the macro and micromachined versions require a back-cavity, which gives the air displaced by the diaphragm motion a place to go. The back-cavity in micromachined microphones requires a through-wafer etch, which is a bottle-neck in the fabrication process, making it an expensive and undesirable from a manufacturing viewpoint.

If the back-cavity etch could be bypassed, the manufacturing process for fabricating micromachined microphones could be simplified and less expensive. Furthermore, if the number of components utilized in the current micromachined microphones could be reduced, then the manufacturing process for micromachined microphones could be further simplified thereby reducing the complexity of the manufacturing process as well as cost.

There is not currently a means for manufacturing a broadband micromachined measurement microphone with fewer components that bypasses the back-cavity etch thereby reducing the complexity of the manufacturing process as well as cost.

### BRIEF SUMMARY

In one embodiment of the present invention, an acoustic sensor comprises a diaphragm attached to a substrate via a plurality of columns forming a cavity. The acoustic sensor further comprises a plurality of structures shorter in length than the plurality of columns attached to the substrate, where the plurality of structures is electrically conductive forming a lower electrode.

In another embodiment of the present invention, an acoustic sensor comprises a diaphragm attached to a substrate via a first set of sidewalls forming a first cavity. The acoustic sensor further comprises a lower electrode attached to the substrate that is capacitively coupled to the diaphragm. The acoustic sensor additionally comprises an upper electrode attached to the substrate via a second set of sidewalls, where the upper electrode has vents such that air pressure from sound waves deflect the diaphragm. Furthermore, the acoustic sensor comprises a second cavity formed between the upper electrode and the diaphragm forming a second capacitively coupled structure.

In another embodiment of the present invention, an acoustic sensor comprises a diaphragm attached to a substrate via a first set of sidewalls. The acoustic sensor further comprises a lower electrode attached to the substrate via a second set of sidewalls, where the lower electrode is formed below the diaphragm and where the lower electrode has vents to a cavity formed between the lower electrode and the substrate. The acoustic sensor additionally comprises a second cavity formed between the lower electrode and the diaphragm.

In a further embodiment of the present invention, an acoustic sensor comprises a planar diaphragm with an active area. The acoustic sensor further comprises a cavity disposed at least partially above a substrate, where the cavity has a wall formed by the diaphragm and where the cavity has a planar area that is greater than the active area of the diaphragm. Furthermore, the acoustic sensor comprises one or more bottom electrodes.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1A is a sketch of the top view of a surface micromachined pressure gradient sensor showing compliant membranes coupled by a rocking structure in accordance with an embodiment of the present invention;

FIG. 1B is a side-view of the rocking beam, showing a pivot on which the structure rotates in accordance with an embodiment of the present invention;

FIG. 2A is a perspective view from a sketch of a fabricated prototype of one embodiment of a compliant, capacitively transduced membrane atop a cavity in accordance with an embodiment of the present invention;

FIG. 2B is a perspective three-dimensional computer rendering of a cross-section of the sensor of FIG. 2A in accordance with an embodiment of the present invention;

FIG. 2C is a perspective three-dimensional computer rendering of the sensor of FIG. 2A with the diaphragm removed in accordance with an embodiment of the present invention;

FIG. 3 is a network model superimposed on a three-dimensional computer rendering of the acoustic sensor with pressure and volume velocity as the effort and flow variables, respectively, used in the network in accordance with an embodiment of the present invention;

FIG. 4 is a simulated response to acoustic and electrostatic actuation and displacement due to thermal-mechanical noise of vent and cavity damping elements in accordance with an embodiment of the present invention;

FIG. 5 is a sketch of a setup used in electrostatic sensitivity measurements for an acoustic sensor in accordance with an embodiment of the present invention;

FIG. 6 is a plot showing the measured and simulated electrostatic response of a device, converted to pressure sensitivity using the effective diaphragm area and applied electrostatic force in accordance with an embodiment of the present invention;

FIG. 7A is a schematic of a readout circuit used for acoustic measurements performed in accordance with an embodiment of the present invention;

FIG. 7B is a schematic of an amplifier with the sensor modeled as a current source in accordance with an embodiment of the present invention;

FIG. 8 is a sketch of an experimental setup for acoustic measurements in accordance with an embodiment of the present invention;

FIG. 9 is a time-of-flight ultrasound measurement providing qualitative demonstration of functionality as an acoustic sensor in accordance with an embodiment of the present invention;

FIG. 10 is a signal to noise ratio simulated from measured flat-band sensitivity compared to measured and simulated total noise and contributions of each noise source in accordance with an embodiment of the present invention;

FIG. 11 is a plot showing acoustic sensitivity measurement in accordance with an embodiment of the present invention;

FIG. 12 is a plot showing the pressure-input referred noise with several amplifier configurations in accordance with an embodiment of the present invention;

FIG. 13 is a cross-section of an alternative embodiment of an acoustic sensor in accordance with an embodiment of the present invention;

FIG. 14 is a cross-section of a further alternative embodiment of an acoustic sensor in accordance with an embodiment of the present invention;

FIG. 15 is a cross-section of an additional alternative embodiment of an acoustic sensor in accordance with an embodiment of the present invention;

FIG. 16 is a flowchart of a method for manufacturing an acoustic sensor, such as the sensor of FIG. 2A, in accordance with an embodiment of the present invention;

FIGS. 17A-17G depict schematic views of fabricating the sensor, such as the sensor of FIG. 2A, using the steps described in the method of FIG. 16 in accordance with an embodiment of the present invention;

FIG. 18 is a flowchart of an alternative method for manufacturing an acoustic sensor, such as the sensor of FIG. 2A, in accordance with an embodiment of the present invention;

FIGS. 19A-19G depict schematic views of fabricating the sensor, such as the sensor of FIG. 2A, using the steps described in the method of FIG. 18 in accordance with an embodiment of the present invention;

FIG. 20 illustrates a process of forming drain pans for etch perforations formed in the acoustic sensor in accordance with an embodiment of the present invention; and

FIG. 21 illustrates a process of sealing drain pans and etch perforations formed in the acoustic sensor in accordance with an embodiment of the present invention.

### DETAILED DESCRIPTION

In the following description, various embodiments are described. For purposes of explanation, specific configurations and details are set forth in order to provide a thorough understanding of the embodiments. It will also be apparent to one skilled in the art that the present invention can be practiced without the specific details described herein. Furthermore, well-known features may be omitted or simplified in order not to obscure the embodiment being described.

Acoustic sensors may be designed to be directional wherein they respond only to in-plane acoustic pressure variations or omni-directional wherein they respond to acoustic pressure variations in myriad planes. Other embodiments may have sensors that have out of plane directional response and cardioid, supercardioid, or other directivity patterns. Embodiments of the present invention may be employed in both types of acoustic sensors, as illustrated herein.

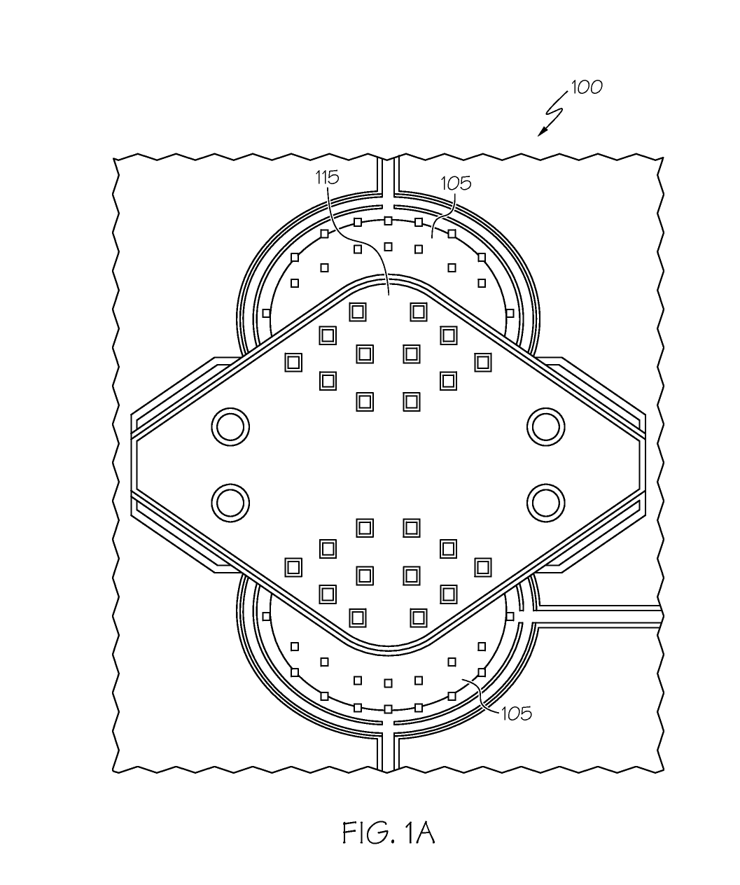

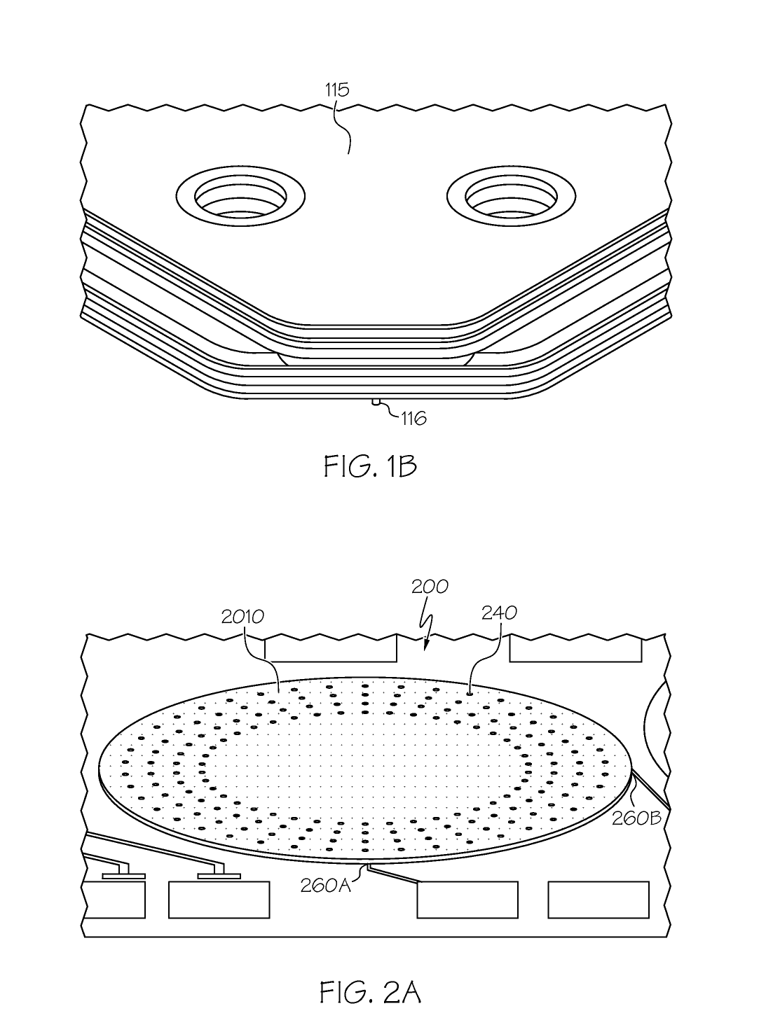

An in-plane prototype acoustic sensor 100 that may incorporate one or more embodiments of the invention is depicted in FIGS. 1A and 1B. FIG. 1A is a sketch of the top view of a surface micromachined pressure gradient sensor 100 showing compliant membranes coupled by a rocking structure 115 in accordance with an embodiment of the present invention. FIG. 1B is a side-view of rocking beam structure 115, showing a pivot 116 on which structure 115 rotates in accordance with an embodiment of the present invention.

Referring to FIGS. 1A and 1B, two diaphragm-based sensors 105 are connected to each other via a rotating beam structure 115. As described in further detail, acoustic sensor 100 is designed to remain rigid in response to omni-directional pressure variations, while rocking in response to in-plane pressure gradients. In one embodiment, the two diaphragm-based sensors 105 have a planar diaphragm having an active area, and a cavity disposed at least partially above a substrate, the cavity having a wall formed by the diaphragm, wherein the cavity has a planar area that is greater than the active area of the diaphragm. More details regarding sensor 100 will be described below.

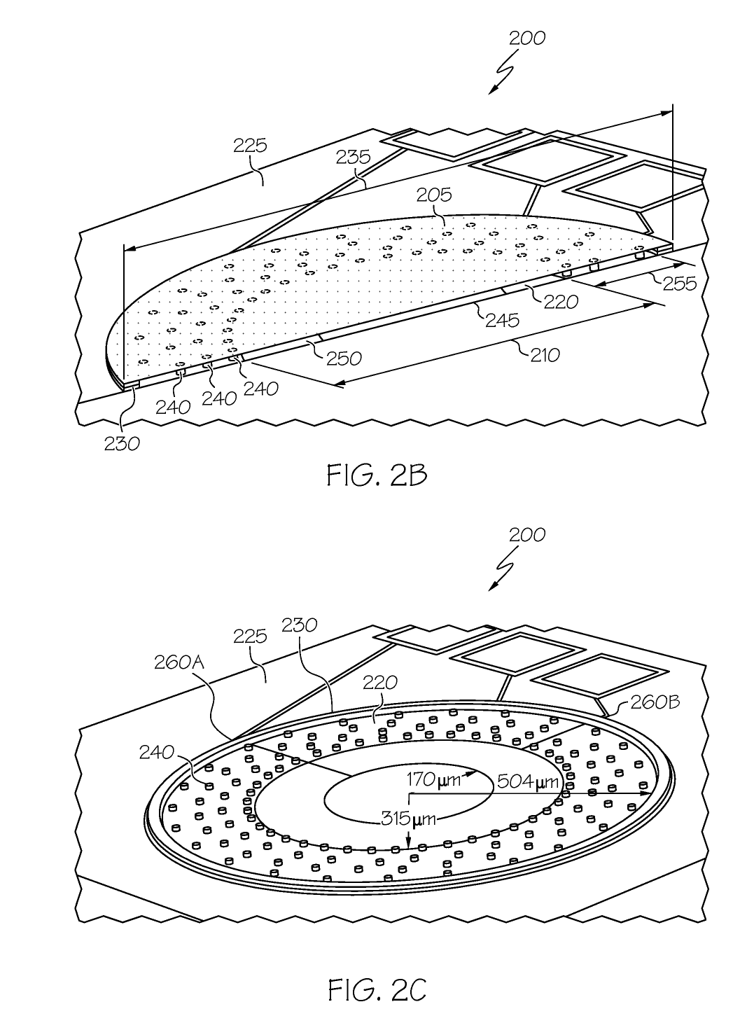

A sketch of an omni-directional prototype acoustic sensor 200 according to one embodiment is illustrated in FIG. 2A. FIG. 2A is a perspective view from a sketch of a fabricated prototype of one embodiment of a compliant, capacitively transduced membrane atop a cavity in accordance with an embodiment of the present invention.

Referring to FIG. 2A, sensor 200 may have a planar diaphragm having an active area, and a cavity disposed at least partially above a substrate, the cavity having a wall formed by the diaphragm, wherein the cavity has a planar area that is greater than the active area of the diaphragm. More details regarding sensor 200 will be described below.

A particular benefit of these embodiments of acoustic sensors 100, 200 is a purely surface micromachined construction in order to facilitate microfabrication compatibility with existing processes established for a gradient sensor. By implementing a surface micromachined construction, the back-cavity etch discussed in the Background section can be bypassed thereby simplifying the manufacturing process and reducing cost. Furthermore, acoustic sensors 200 of the present invention utilize fewer components than prior broadband measurement microphones thereby further simplifying the manufacturing process and further reducing cost. In some embodiments, compatibility means simultaneous fabrication using the same process. In further embodiments, the same process may be used on the same chip or for each sensor on its own chip. Generally speaking, in comparison to conventional instrumentation microphones, the purely surface micromachined acoustic sensors 100, 200 disclosed herein may have advantages of small size and lower-cost fabrication due to the simple surface micromachined construction. Some embodiments of the sensors use materials stable to relatively high temperatures compared to lead zirconium titanate (PZT) and other Curie-temperature limited ceramic based microphones, which may offer an advantage for some applications. The sensor fabrication could also be easily adapted to fabrication with silicon carbide (SiC), diamond, or other materials well suited for high temperature and harsh environment applications. Compared to conventional bulk-micromachined capacitive broadband microphones, the sensors introduced herein have perhaps simpler fabrication, but may exhibit smaller capacitance and higher noise.

### Description of and Embodiment

Three-dimensional CAD sections of the omni-directional embodiment illustrated in FIG. 2A are illustrated in FIGS. 2B and 2C, highlighting the construction of an example sensor 200. Other embodiments may have a different construction and different measurements. FIG. 2B is a perspective three-dimensional computer rendering of a cross-section of sensor 200 of FIG. 2A in accordance with an embodiment of the present invention. FIG. 2C is a perspective three-dimensional computer rendering of sensor 200 of FIG. 2A with the diaphragm removed in accordance with an embodiment of the present invention.

Referring to FIGS. 2B and 2C, FIGS. 2B and 2C illustrate an acoustic sensor 200 having a planar diaphragm 205 that has an active area 210, and a cavity 220 disposed at least partially above a substrate 225, cavity 220 having a wall formed by diaphragm 205, wherein cavity 220 has a planar area 235 that is greater than the active area of diaphragm 205. This embodiment has a cavity 220 having an 11 μm tall cylindrical air volume with a 504 μm radius enclosed by a 2 μm thick polysilicon diaphragm layer 205. Polysilicon diaphragm 205 has a clamped/clamped boundary condition at the 504 μm radius perimeter, also called the “extents” of diaphragm 205. The extents of diaphragm 205 are affixed to a sidewall 230 that is attached to the substrate 225. In the outer region of diaphragm 205, from a radius of approximately 315 μm to 504 μam, diaphragm 205 is attached to a plurality of rigid post structures 240, which prevent that portion of diaphragm 205 from moving during operation. The active area 210 of diaphragm 205 has a radius of approximately 315 μm.

In the center region of diaphragm 205, from a radius of approximately 0 μm to 315 μm, no post structures exist and diaphragm 205 is free to move toward and away from the bottom electrode, that is, to vibrate. FIG. 2C is a CAD image in which diaphragm 205 has been removed in order to highlight post structures 240 and bottom electrodes 245, 250, which may have the same 315 μm radius as the movable portion “active area” 210 of diaphragm 205. This particular embodiment has dual, concentric bottom electrodes 245, 250 to allow 3-port operation. Some embodiments may have a single bottom electrode, or the bottom electrodes 245, 250 may be electrically connected to function as a single bottom electrode. A single electrode configuration was used for the subsequent evaluations discussed herein.

The active region 210 of the structure with a radius from 0 μm to 315 μm is therefore similar to a conventional variable parallel plate capacitive transducer, having an electrically conductive, pressure-sensitive diaphragm 205 suspended above a rigid bottom electrode, however, this embodiment has a cavity that extends laterally (extended cavity region 255) beyond the active region of a conventional transducer. In some embodiments, diaphragm 205 may comprise a conductively doped material, such as silicon acting as an electrode, while in other embodiments, diaphragm 205 may have a layer of metal or other conductive material deposited on it to form an electrode. In further embodiments, electrical connection may be made to the diaphragm electrode through sidewall 230. In this embodiment, cavity 220 of sensor 200 comprises the air volume directly underneath the movable “active” portion of diaphragm 205, and also the air volume in extended cavity region 255 with a radius from 315 μm to 504 μm.

In some embodiments, the air volume in extended cavity region 255 may allow diaphragm 205 to move more freely than if the air volume was restricted to active area 210. More specifically, the larger air volume, as compared to a conventional transducer, may provide less compressive resistance to movement of diaphragm 205, making sensor 200 more sensitive.

In some embodiments, two small openings 260A, 260B along the outer perimeter in sidewall 230 allow the bottom electrode traces to be routed to bond pads near the edge of the chip, as can be seen in FIG. 2C. Small openings 260A, 260B may also form a low frequency vent to acoustic pressure, similar to a vent intentionally introduced in capacitive MEMS microphones to prevent a DC response to ambient environmental pressure fluctuations. Such vents 260A, 260B may be designed to allow environmental pressure variations to equalize the pressure on both sides of diaphragm 205 so improved sensitivity stability and response of sensor 200 may be achieved. However, the size and location of vents 260A, 260B may be designed to minimally affect the sensor's response to acoustic sound waves. More specifically, in some embodiments, vents 260A, 260B may be small enough such that transient sound pressure waves exert a force on only the exposed side of diaphragm 205.

In some embodiments, other cavity geometries may be used while still achieving the advantages described herein. For example, some embodiments may have a larger or smaller diaphragm radius while other embodiments may have a taller or shorter cavity height. Some embodiments may optimize the sensor dimensions to improve the signal to noise ratio of the sensor. For example, some embodiments may be designed to have a very short cavity height to improve the capacitance and a large perimeter to maximize the diaphragm deflection. A design trade-off exists between minimizing thin air film effects and maximizing sensing capacitance. Both parameters are a function of both active sensing area and gap height.

In further embodiments, dual bottom electrodes 245, 250 may be used to apply different bias voltages to the two electrodes. In some embodiments, a higher bias voltage may be applied to outer electrode 250 as compared to inner electrode 245. Other methods of biasing may be used, such as those employed in capacitive micromachined ultrasonic transducers known in the art at “CMUTs.”

In other embodiments, there may be no posts resulting in sensor 200 resembling a large diameter, un-sealed CMUT. Deflection may be less around the clamped boundary, so air would tend to be pushed toward the edges when diaphragm 205 deflects.

Device Model & Electrostatic Response

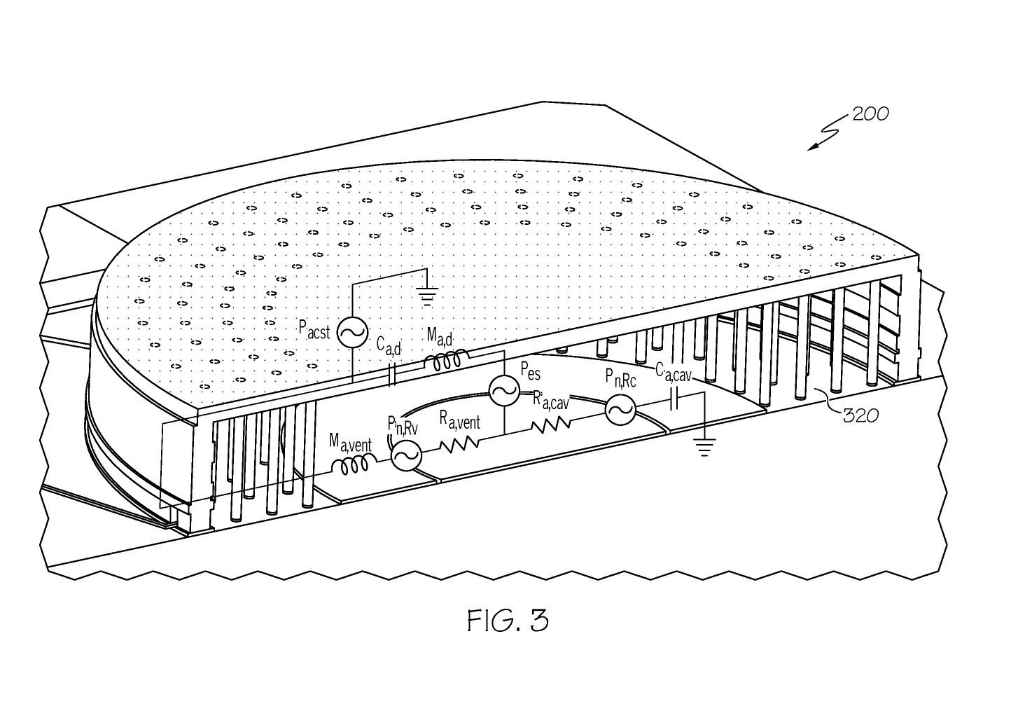

FIG. 3 presents an example network model superimposed onto a cross-section of acoustic sensor 200, with pressure and volume velocity as the effort and flow variables, respectively, used in the network in accordance with an embodiment of the present invention. Referring to FIG. 3, in conjunction with FIGS. 2A-2C, the effort and flow variables are pressure and volume velocity, respectively. P_{acst} and Pₑₛ represent acoustic and electrostatic actuation, respectively. P_{n,Rc} and P_{n,Rv} represent thermal mechanical noise introduced by the acoustic damping elements in the system. All impedances presented are therefore acoustical impedances. The 2.25 μm thick diaphragm 205 is modeled using a clamped-clamped boundary condition with a 305 μm radius. Table I provides values and a description for all elements in the network. The use of a resistor in series with the cavity compliance is an ad-hoc way to capture the physical trend that the cavity 320 presents compliance in series with diaphragm 205 at low frequencies, and transitions to a resistive impedance at higher frequencies. The transition frequency for the particular R_{α,cav} and C_{α,cav} values used in the model is 105 kHz. In the passband of sensor 200, cavity 320 presents a compliance, and in the passband, diaphragm 205 is responsible for 37% of the total acoustic stiffness, with the cavity responsible for 63%. Together, the total simulated center point diaphragm deflection in response to uniformly applied acoustic pressure is 0.40 nm/Pa.

TABLE 1
SUMMARY OF NETWORK PARAMETERS

| Symbol | Description | Note | Value | Units |
|---|---|---|---|---|
| C_{a,cav} | Acoustical compliance of back cavity | V_{cav} = 8.77e − 12 m³ ${C}_{a , cav} = \frac{{V}_{cav}}{{ρc}^{2}}$ | 6.32e − 17 | $\frac{{m}^{3}}{Pa}$ |
| R_{a,cav} | Acoustical resistance associated with back cavity | Fitted, not modeled | 2.4e10 | $\frac{Pa \cdot s}{{m}^{3}}$ |
| R_{a,vent} | Acoustical resistance of the vent | Vent dimensions: h = 2 μm l = 40 μm w = 20 μm ${R}_{a , vent} = \frac{{12}_{η i}}{{wh}^{3}}$ | 5.58e13 | $\frac{Pa \cdot s}{{m}^{3}}$ |
| m_{a,vent} | Acoustical mass of the vent | Not included in simulation | — | $\frac{kg}{{m}^{4}}$ |
| m_{a,d} | Acoustical mass of the diaphragm | m_{actual} = 1.63e − 9 kg m_{eff} = 2.99e − 10 kg^{†}^̅{̅τ̅}̅ ${m}_{a , d} = \frac{{m}_{eff}}{{A}_{eff}^{2}}$ | 2.83e4 | $\frac{kg}{{m}^{4}}$ |
| C_{a,d} | Acoustical compliance of the diaphragm | Cₘ = 0.0103 m/N^̅{̅τ̅}̅ fₙ = 90.6 kHz C_{a,d} = CₘA_{eff}² | 1.09e − 16 | $\frac{{m}^{3}}{Pa}$ |
| P_{acst} | Acoustical pressure input | — | — | Pa |
| Pₑₛ | Electrostatic pressure input | — | — | Pa |
| A_{eff} | Effective area of the diaphragm | A_{eff} = 0.33A_{actual}^{†} | 1.03e − 7 | m² |

^̅{̅τ̅}̅Simulated using finite element analysis
^{†}Effective mass (m_{eff}) and effective area (A_{eff}) account for non-uniform deflection of the membrane resulting from clamped boundary conditions.

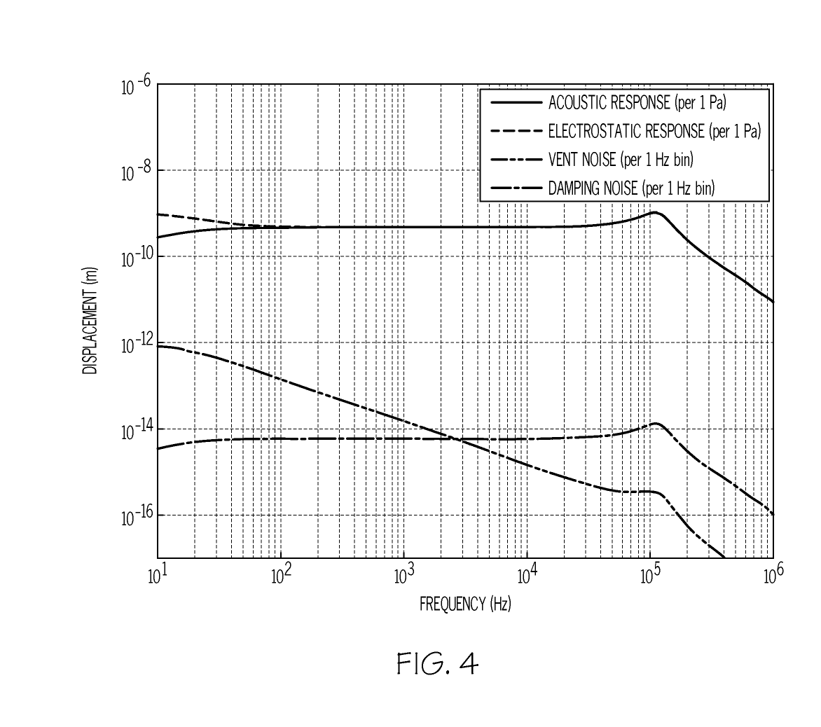

FIG. 4 is a simulated response to acoustic and electrostatic actuation and displacement due to thermal-mechanical noise of vent and cavity damping elements in accordance with an embodiment of the present invention. Referring to FIG. 4, FIG. 4 presents the results of several simulations following the network in FIG. 3. The center point diaphragm displacement is simulated in response to 1 Pa acoustic pressure, and 1 Pa electrostatic (ES) pressure. The two responses differ only at low frequency. The acoustic response shows a low frequency pole (i.e., lower limiting frequency) common to conventional capacitive MEMS microphones. Analysis of the network in FIGS. 2A-2C provides an analytical expression for the pole frequency in Equation (1) as:

$${f}_{c} = \frac{1}{2 π {C}_{a , d} {R}_{a , v} ( 1 + {C}_{a , cav} / {C}_{a , d} )} \qquad ( 1 )$$

For the particular prototype presented here, f_{c}=16.5 Hz. The network model is also used to simulate the diaphragm displacement in response to thermal mechanical noise induced by the vent and cavity acoustical resistances.

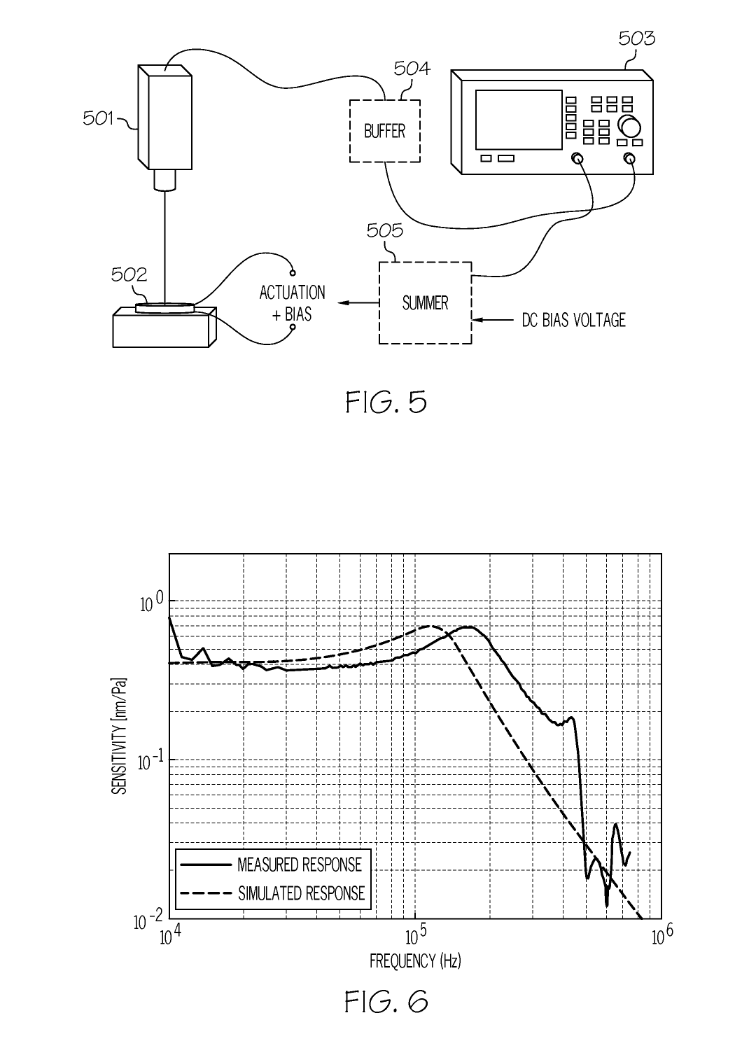

FIG. 5 is a sketch of a setup used in electrostatic sensitivity measurements for acoustic sensor 200 in accordance with an embodiment of the present invention. Referring to FIG. 5, in conjunction with FIGS. 2A-2C, the dynamic frequency response to ES inputs was measured by exciting the diaphragm over a broad frequency range while recording the diaphragm displacement with a high-speed Laser Doppler Vibrometer (LDV) 501 (e.g., “Polytec OFV-505” meter from Polytec). ES response characterization has an advantage over acoustic response characterization in that the force is applied only locally to the structure 502, and can be applied uniformly over a broad frequency—up to and beyond the fundamental resonance frequency of device 502. As illustrated in FIG. 5, a DC voltage is summed by summer 505 (a summing circuit) with a varying AC signal from a spectrum analyzer 503 to enable biasing. Device 502 was biased at 50 V and a small 1 V signal was swept across device 502 using a tracking generator function of a 2 GHz spectrum analyzer (Rigol DSA815) 503 while the output from Laser Doppler Vibrometer (LDV) 501 was fed back into spectrum analyzer 503 to record the displacement, as shown in the sketch in FIG. 5. Device 502 is actuated with a swept sine signal applied from spectrum analyzer 503 while the diaphragm velocity is measured by LDV 501. An impedance buffer 504 is used to interface with the 50Ω input terminal of spectrum analyzer 503.

FIG. 6 is a plot showing the measured and simulated electrostatic response of device 502 (FIG. 5), converted to pressure sensitivity using the effective diaphragm area and applied electrostatic force in accordance with an embodiment of the present invention. Referring to FIG. 6, the peak in the response occurs at a frequency of 163 kHz, and the response falls to 3 dB below the flat-band compliance at 230 kHz. Device 502 can therefore measure airborne ultrasound up to 230 kHz frequencies. The simulation from FIG. 4 is also superimposed on FIG. 6. While the simulation has excellent agreement with the flat-band sensitivity at 0.4 nm/Pa, the simulation under predicts the resonance of device 502 which is likely due to the overly simplistic ad-hoc approach to modeling the squeeze film dynamics in the air cavity.

Acoustic Measurements and SNR Characteristics

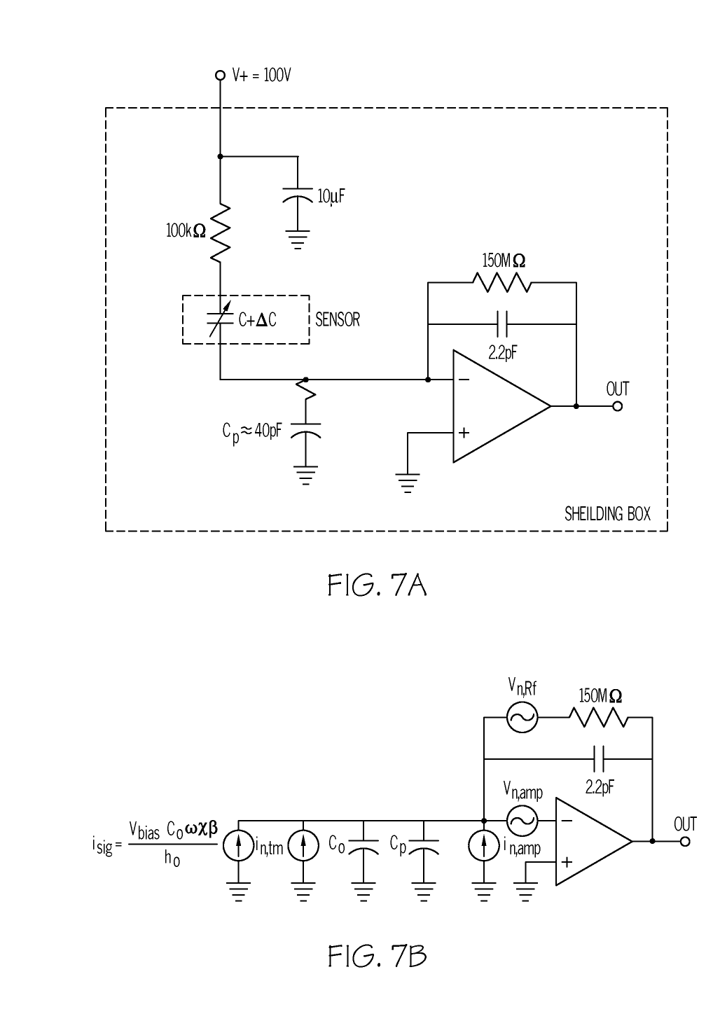

FIG. 7A is a schematic of the readout circuit used for acoustic measurements for device 502 (FIG. 5) in accordance with an embodiment of the present invention. Referring to FIG. 7A, a bias voltage of 100 V from an AA Lab Systems model A-301 high voltage supply is passed through a passive low pass filter (LPF) network for noise considerations before falling across the device capacitance. A charge amp configuration is used with feedback parameters. The device capacitance was computed as 0.25 pF, and was much smaller than the parasitic capacitance contained on the chip and also in the protoboard amplifier setup, the total of which is estimated as 40 pF. The virtual ground prevents signal attenuation due to Cₚ, but Cₚ admits excessive current to ground arising from the voltage noise internal to the operational amplifier, which in turn flows through the feedback network to create a noise at the operational amplifier (“op amp”) output.

FIG. 7B is a schematic of an amplifier with the sensor modeled as a current source in accordance with an embodiment of the present invention. Referring to FIG. 7B, FIG. 7B presents the small-signal AC circuit that results upon application of the bias. Relevant noise sources are included along with the expression for the charge generated by the variable capacitance in response to diaphragm displacements.

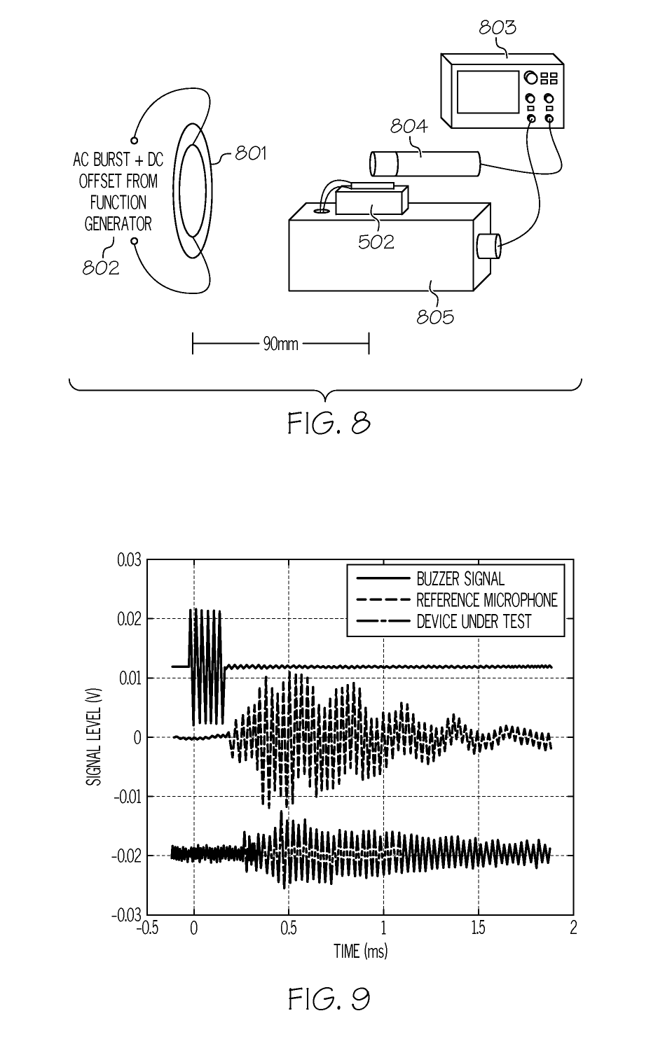

Transient ultrasonic waveforms were recorded to verify device functionality. FIG. 8 is a sketch of an experimental setup for acoustic measurements in accordance with an embodiment of the present invention. FIG. 9 is a time-of-flight ultrasound measurement providing qualitative demonstration of functionality as an acoustic sensor in accordance with an embodiment of the present invention. Referring to FIGS. 8 and 9, FIG. 8 presents a schematic of the setup in which a narrowband piezoelectric buzzer 801 with a resonance at 30.4 kHz was used to generate a finite duration tone burst via generator 802. The input waveform was captured with an oscilloscope 803 and is depicted in FIG. 9, along with the acoustic waveform capture by a GRAS microphone model 40 AC 804 connected to a shielded box housing readout and biasing electronics unit 805. FIG. 9 also includes the ultrasonic waveform as measured by device 502 (FIG. 5) under study. To verify the absence of any electromagnetic coupling, the sound was blocked using a metal plate and it was confirmed that no signals were present. Further, the time delay between the voltage input to buzzer 801 and the measured acoustic response is as expected given the 90 mm distance noted in FIG. 8. Referring to FIG. 9, the start of the input to buzzer 801 is 29.8 μs, while the start of the DUT 502 response is 271.4 μs, providing a time-of-flight measurement of 241.6 μs. Using 344 m/s for speed of sound, 83 mm distance is computed which is consistent with the rough measurement made of 90 mm using a ruler in the lab.

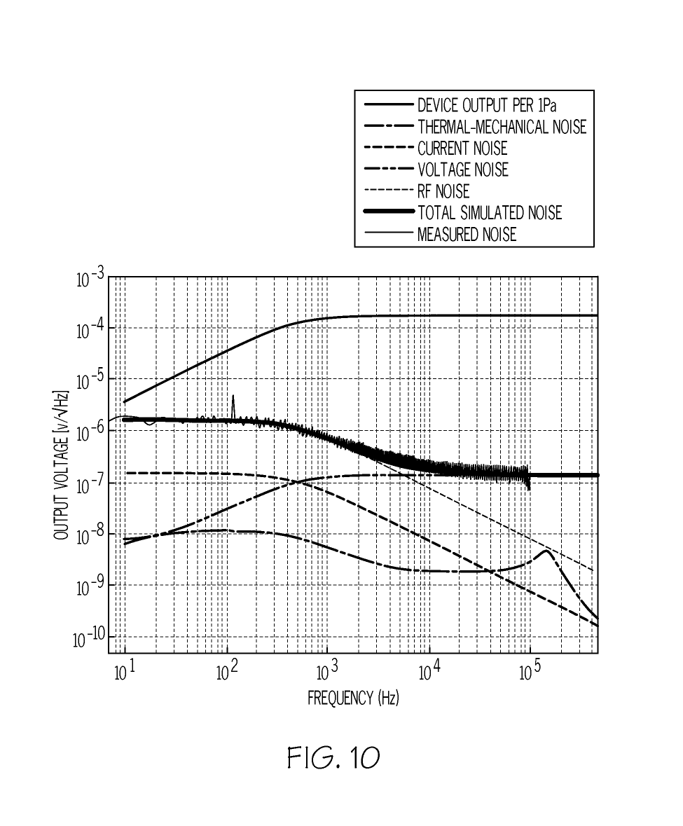

FIG. 10 is a signal to noise ratio simulated from measured flat-band sensitivity compared to measured and simulated total noise and contributions of each noise source in accordance with an embodiment of the present invention. Referring to FIG. 10, the simulated amplifier output in response to 1 Pa sound pressure is presented in FIG. 10. The particular set of feedback values in this embodiment results in a TIA amplifier region below 482 Hz, and a charge amplifier region above 482 Hz and through the passband of the device. A quantitative measure of device sensitivity was performed at 2,256 Hz using the same setup presented in FIG. 8.

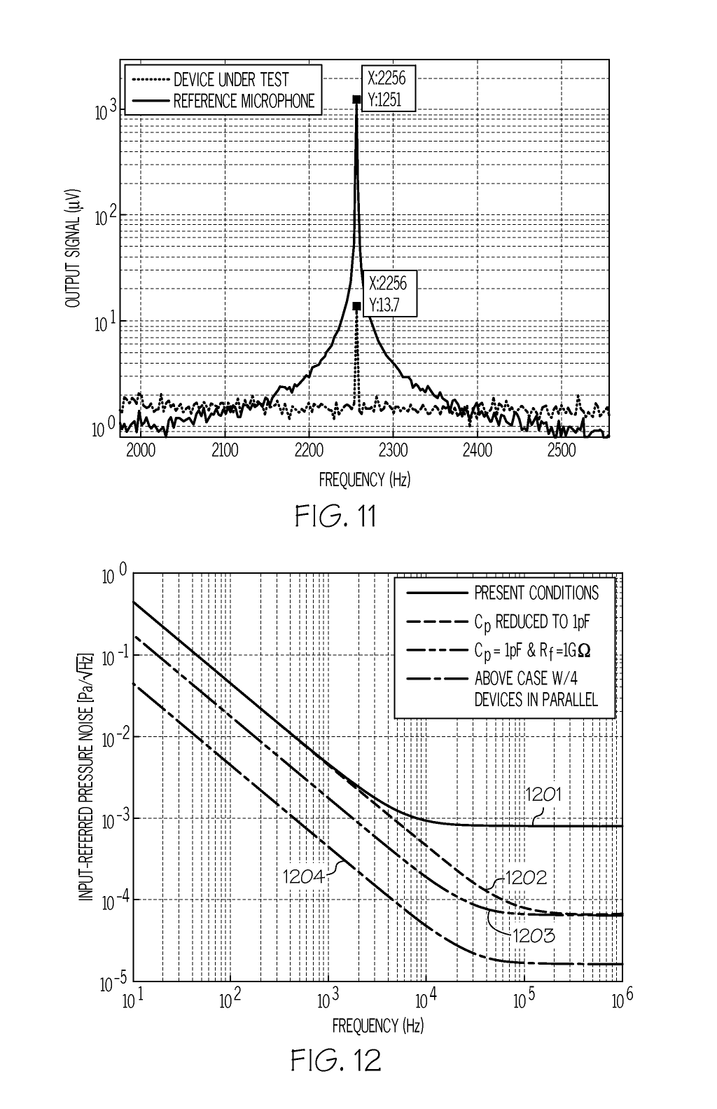

FIG. 11 is a plot showing acoustic sensitivity measurement in accordance with an embodiment of the present invention. Referring to FIG. 11, FIG. 11 presents the fast Fourier transform (FFT) of the G.R.A.S. microphone (G.R.A.S. Sound & Vibration A/S, Skovlytoften 33, DK-2840 Holte, Denmark) and DUT microphone output in response to a continuous wave signal. The G.R.A.S. microphone has a known calibration scale factor equal to 14.5 mV/Pa. From FIG. 11, the signals from the G.R.A.S. microphone and the DUT are 1.25 mV and 13.7 μV, respectively, implying a device sensitivity that is given by Equation (2) as equal to

$${S}_{acst} = \frac{{V}_{device}}{{V}_{ref}} {S}_{ref} \\ \frac{13.7 µV}{1.25 mV} = 14.5 mV = 0.159 mV \qquad ( 2 )$$

The result of (2) may also be expressed as 0.159 mV/Pa. From the simulation in FIG. 8, the simulated sensitivity at 2,256 Hz is 0.167 mV, a difference of 4.8% from the measured value.

FIG. 10 also presents the measured and simulated noise appearing at the amplifier output. The noise is generated by the feedback resistor thermal noise at low frequency and by operational amplifier voltage noise at high frequency. These trends are identical to those presented by Martin, et al. who also used a charge amp readout of a broadband capacitive MEMS acoustic sensor having a different construction than the sensor described herein. See, for example, D. T. Martin et al., Journal of Microelectromechanical Systems, vol. 16, pp. 1289-1302, 2007. As noted by Martin et al., noise is this region is directly proportional to Cₚ, so other embodiments may benefit from reducing on-chip parasitic capacitance. The simulated thermal-mechanical noise spectrum at the amplifier output is included for completeness, but does not dominate the output noise across any region of the spectrum. In some embodiments, it may be ideal to design readout electronics, such that all electronic noise is below the thermal-mechanical noise of the sensor in the band of interest.

Discussion and Conclusion

FIG. 12 is a plot showing the pressure-input referred noise with several amplifier configurations in accordance with an embodiment of the present invention. Referring to FIG. 12, FIG. 12 presents the pressure-input referred noise of the microphone, obtained by dividing the measured noise by the device sensitivity. At 1 kHz, the noise is 4.5 mPa/\sqrt{Hz} (47 dB in a 1 Hz bin), and 0.80 mPa/\sqrt{Hz} (32 dB) in the flat region above 10 kHz as shown in line 1201. For applications benefiting from lower noise floors, the envelope limits of the sensor and charge amp configuration were investigated. FIG. 12 also plots the simulated noise resulting from an embodiment in which parasitic capacitance has been successfully reduced to a value of 1.0 pF as shown in line 1202. In this case, noise in the flat region is reduced to 9.5 dB (1 Hz bin), but this improvement alone has no impact on the noise at 1 kHz. An increase in feedback resistance from 150 MSΩ to 1 GΩ reduces the noise at 1 kHz down to 1.7 mPa/\sqrt{Hz}, or 38.6 dB as shown in line 1203. Additional improvements would need to arise from the use of multiple sensors configured in close proximity to create an array summed in parallel. FIG. 12 presents the simulated noise assuming a “4-pack” of sensors of the type as shown in line 1204. Noise in this case is 0.44 mpa/\sqrt{Hz} (26.8 dB) at 1 kHz and 16.2 μPa (−1.83 dB) above 30 kHz. Considering the radius of the prototype is 504 μm, the hypothetical 4 sensor array would occupy approximately 2 mm×2 mm area.

The measured noise figures for the fabricated prototype fall within the range of results reported by other sensor technologies as summarized by Martin, even though Martin's construction is quite different from the embodiments described herein. See, for example, D. T. Martin et al., Journal of Microelectromechanical Systems, vol. 16, pp. 1289-1302, 2007. It may be difficult to make a direct sensor to sensor comparison based on noise alone, since many other factors may be important depending on the device application (e.g., bandwidth of operation, size, and dynamic range). Other non-quantifiable constraints also influence the choice of broadband sensor technology. In one particular embodiment, it may be desirable to pursue a purely surface micromachined solution to maintain compatibility with a fabrication process already established for vacuum-sealed pressure-gradient sensors. In other embodiments, it may be desired to have more than 200 kHz sensing bandwidth. An embodiment disclosed herein meets this requirement with a 230 kHz 3 dB bandwidth. Further embodiments may include integration of omnidirectional and pressure-gradient surface micromachined sensors on a common silicon die.

### Other Embodiments

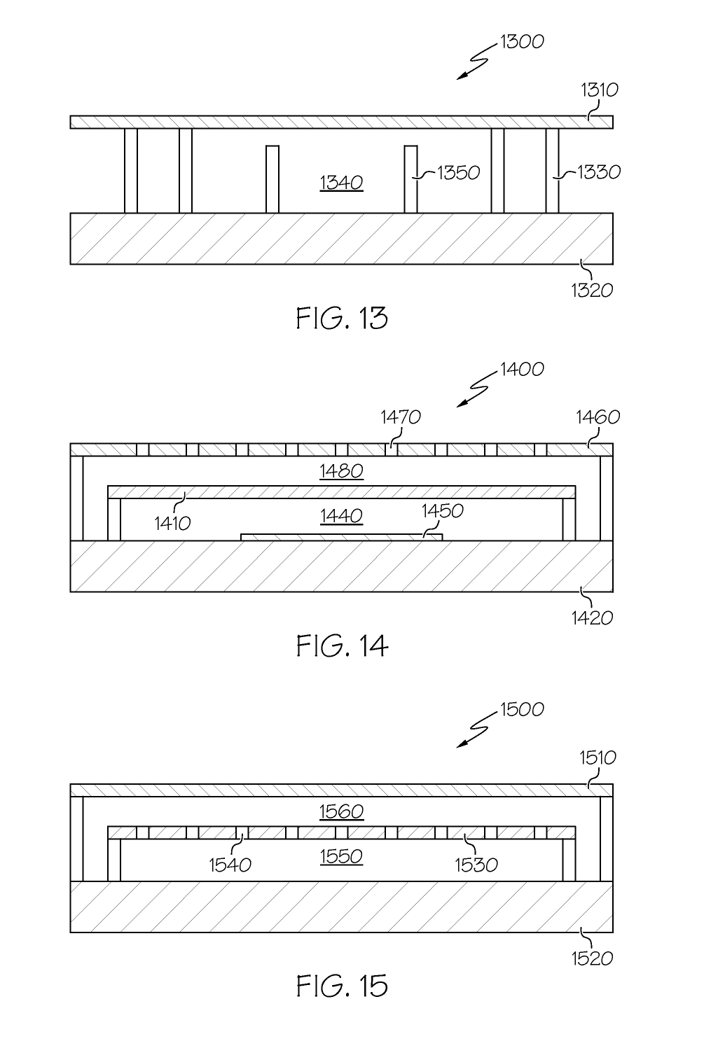

FIG. 13 is a cross-section of an alternative embodiment of an acoustic sensor 1300 in accordance with an embodiment of the present invention. Referring to FIG. 13, sensor 1300 includes a diaphragm 1310 that is attached to a substrate 1320 with a plurality of rigid columns 1330 forming a cavity 1340. A plurality of short structures 1350 may be electrically conductive forming a lower electrode for the sensor. This embodiment may be useful where the cavity 1340 is relatively deep and increased sensitivity may be desired. The relatively small gap between the short structures 1350 and the conductive diaphragm 1310 may provide increased capacitive sensitivity. This embodiment may also have sidewalls and vents as illustrated herein. In one embodiment, cavity 1340 contains a barometric vent to the outside world.

FIG. 14 is a cross-section of a further alternative embodiment of an acoustic sensor 1400 in accordance with an embodiment of the present invention. Referring to FIG. 14, sensor 1400 includes a diaphragm 1410 that is attached to a substrate 1420 with a sidewall forming cavity 1440. A lower electrode 1450 is capacitively coupled to the conductive diaphragm 1410. An upper electrode 1460 has vents 1470 such that air pressure from sound waves may deflect the diaphragm 1410. A cavity 1480 may be formed between upper electrode 1460 and diaphragm 1410 forming a second capacitively coupled structure for increased sensitivity. In this embodiment, bias voltage may be applied between diaphragm 1410 and lower electrode 1450, and between diaphragm 1410 and upper electrode 1460. The bias voltages may be balanced such that diaphragm 1410 is physically centered between upper electrode 1460 and lower electrode 1450. The embodiment shown in FIG. 14 is useful as cavity 1440 may be deep, and close proximity of diaphragm 1410 to upper electrode 1460 provides high sensitivity. In one embodiment, the sidewalls attaching diaphragm 1410 to substrate 1420 contain at least one opening forming a barometric vent.

FIG. 15 is a cross-section of an additional alternative embodiment of an acoustic sensor 1500 in accordance with an embodiment of the present invention. Referring to FIG. 15, sensor 1500 includes a diaphragm 1510 that is attached to a substrate 1520 with a sidewall. A lower electrode 1530 is formed below diaphragm 1510 and has air vents 1540 to a cavity 1550. A second cavity 1560 is formed between lower electrode 1530 and diaphragm 1510. The embodiment shown in FIG. 15 is useful as cavity 1550 may be deep and cavity 1560 (which is less deep than cavity 1550) is desirable for high sensitivity. In one embodiment, the sidewalls attaching diaphragm 1510 to substrate 1520 contain at least one opening forming a vent.

Example Manufacturing Processes

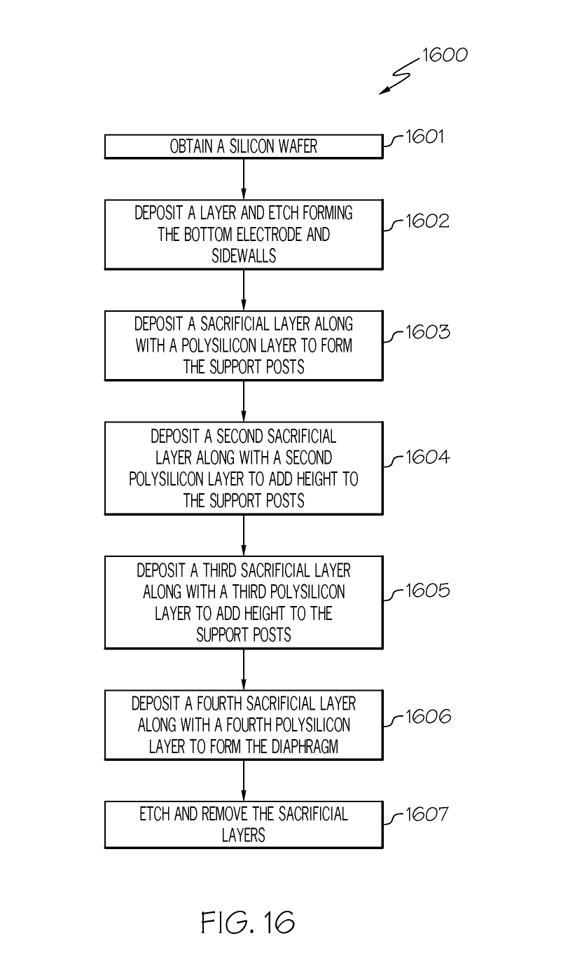

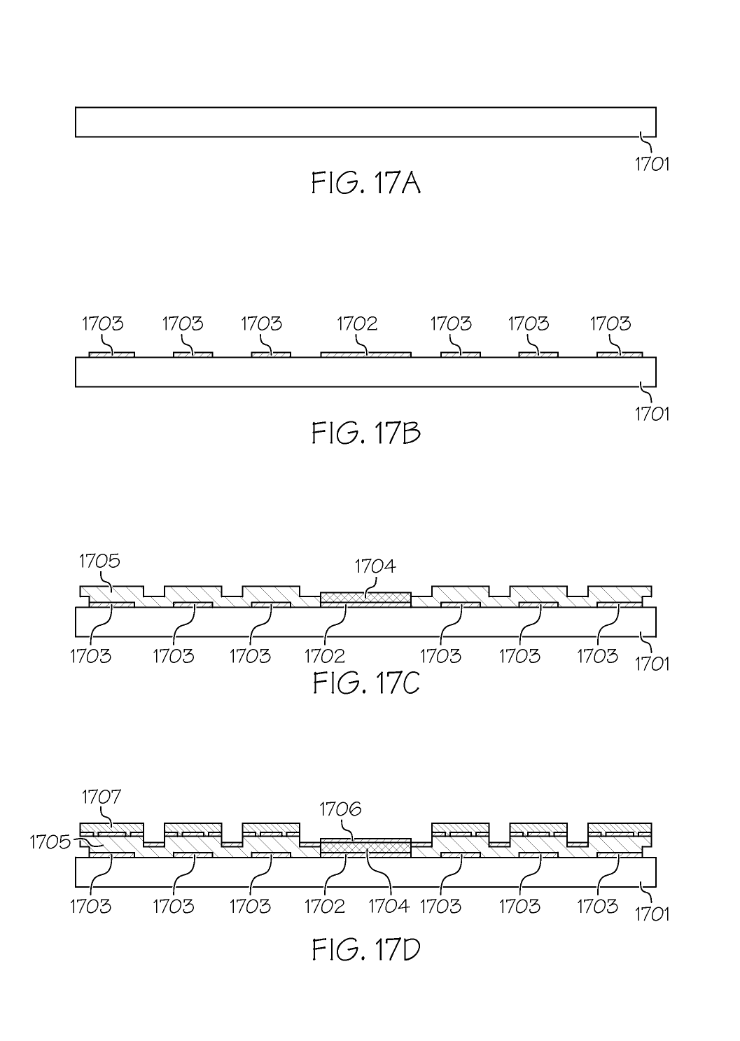

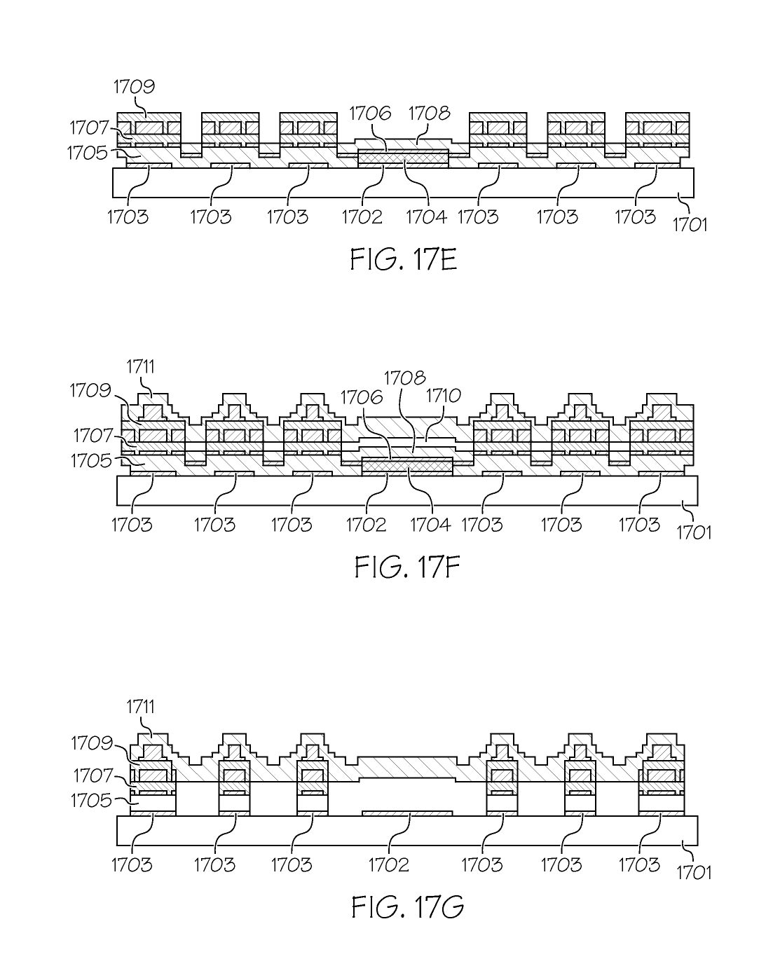

Myriad processes may be used to manufacture embodiments of the acoustic sensor disclosed herein. One example manufacturing process is depicted in FIG. 16. FIG. 16 is a flowchart of a method 1600 for manufacturing an acoustic sensor, such as sensor 200, in accordance with an embodiment of the present invention. FIG. 16 will be discussed in conjunction with FIGS. 17A-17G, which depict schematic views of fabricating sensor 200 using the steps described in method 1600 of FIG. 16 in accordance with an embodiment of the present invention.

Referring to FIG. 16, in conjunction with FIGS. 17A-17G, in step 1601, a silicon wafer 1701 is obtained as shown in FIG. 17A.

In step 1602, a layer (e.g., MMpoly0) is deposited and etched forming the bottom electrode 1702 and sidewalls 1703 as shown in FIG. 17B.

In step 1603, a sacrificial layer 1704 is deposited along with a polysilicon layer 1705 to form the support posts as shown in FIG. 17C.

In step 1604, a second sacrificial layer 1706 is deposited along with a second polysilicon layer 1707 to add height to the support posts as shown in FIG. 17D.

In step 1605, a third sacrificial layer 1708 is deposited along with a third polysilicon layer 1709 to add height to the support posts as shown in FIG. 17E.

In step 1606, a fourth sacrificial layer 1710 is deposited along with a fourth polysilicon layer 1711 forming the diaphragm as shown in FIG. 17F.

In step 1607, an etch is performed and the sacrificial layers 1704, 1706, 1708, 1710 are removed as shown in FIG. 17G.

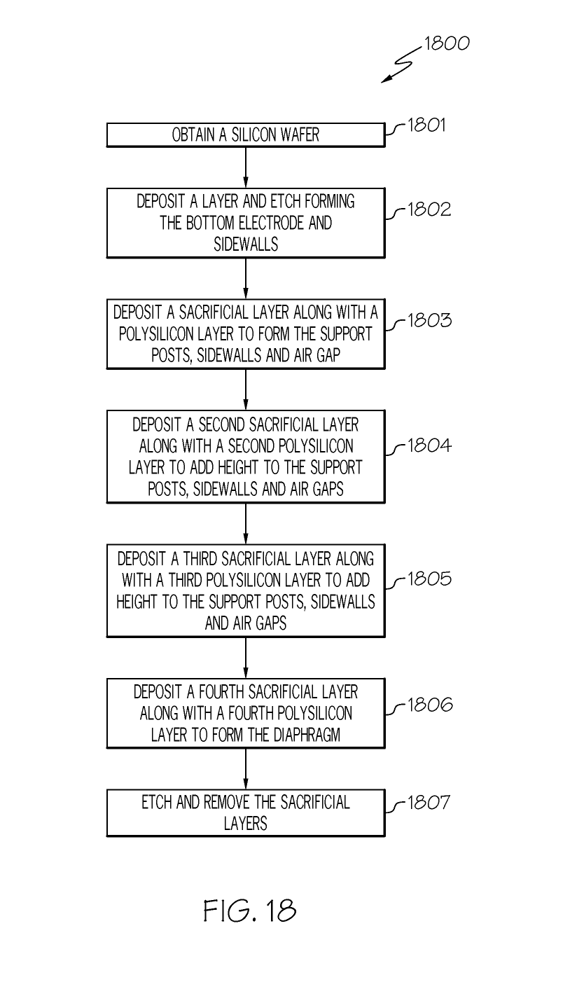

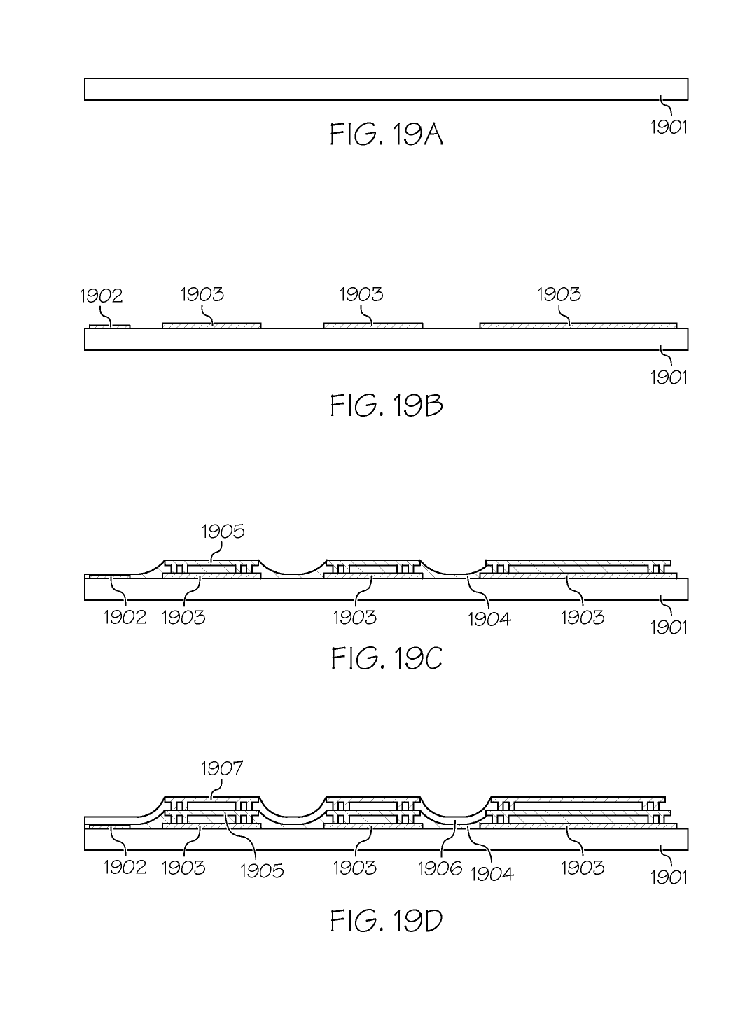

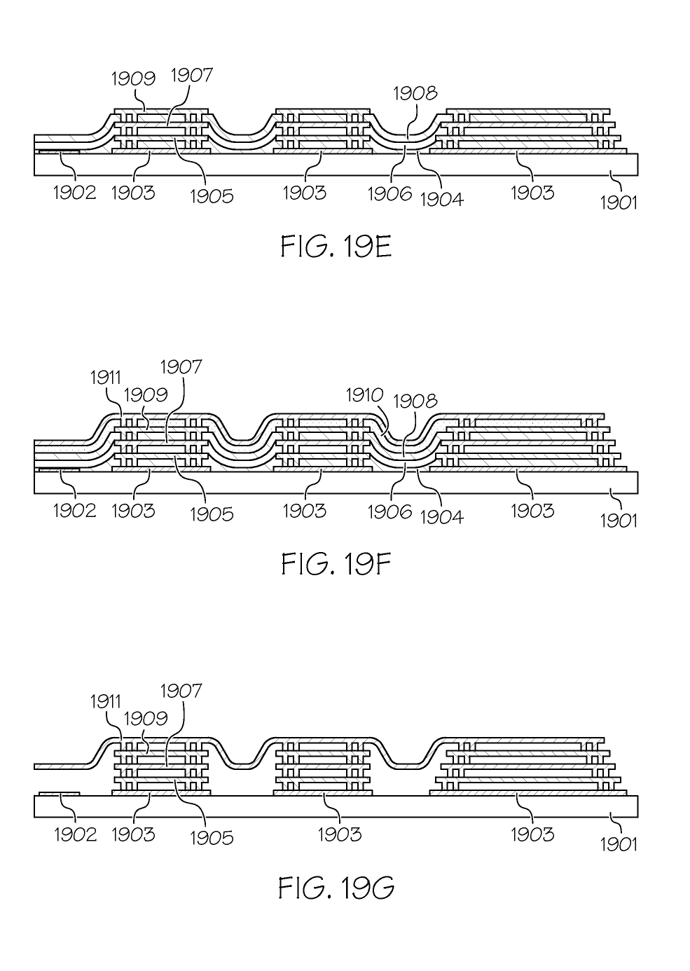

Another example manufacturing process is depicted in FIG. 18. FIG. 18 is a flowchart of a method 1800 for manufacturing an acoustic sensor, such as sensor 200, in accordance with an embodiment of the present invention. FIG. 18 will be discussed in conjunction with FIGS. 19A-19G, which depict schematic views of fabricating sensor 200 using the steps described in method 1800 of FIG. 18 in accordance with an embodiment of the present invention.

Referring to FIG. 18, in conjunction with FIGS. 19A-19G, in step 1801, a silicon wafer 1901 is obtained as shown in FIG. 19A.

In step 1802, a layer (e.g., MMpoly0) is deposited and etched forming the bottom electrode 1902 and sidewalls 1903 as shown in FIG. 19B.

In step 1803, a sacrificial layer 1904 is deposited along with a polysilicon layer 1905 to form the support posts, sidewalls and air gaps as shown in FIG. 19C.

In step 1804, a second sacrificial layer 1906 is deposited along with a second polysilicon layer 1907 to add height to the support posts, sidewalls and air gaps as shown in FIG. 19D.

In step 1805, a third sacrificial layer 1908 is deposited along with a third polysilicon layer 1909 to add height to the support posts, sidewalls and air gaps as shown in FIG. 19E.

In step 1806, a fourth sacrificial layer 1910 is deposited along with a fourth polysilicon layer 1911 forming the diaphragm as shown in FIG. 19F.

In step 1807, an etch is performed and sacrificial layers 1904, 1906, 1908, 1910 are removed as shown in FIG. 19G.

In some embodiments, the stacking of multiple polysilicon layers may result in the buildup of residual stresses causing the structures to tilt, warp or become deformed. In one embodiment, these effects may be mitigated by alternating layers of polysilicon with silicon dioxide or another material to relieve intrinsic stresses.

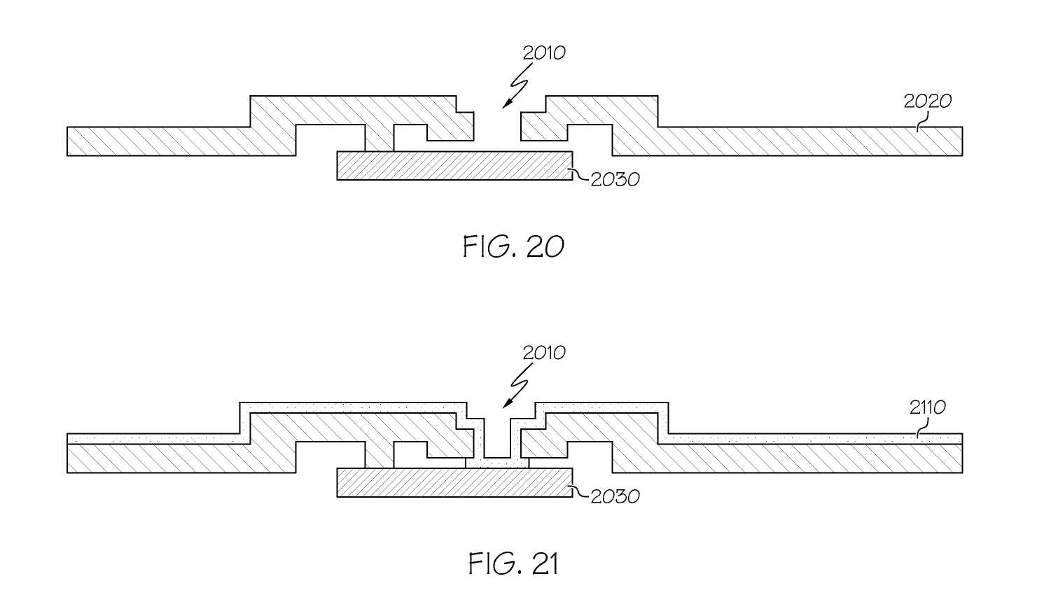

In some embodiments, removal of the sacrificial layers may require forming perforations in the diaphragm to allow an etchant to reach the sacrificial layers. Such perforations may allow air pressure from impinging sound waves to bleed through the diaphragm, reducing the sensitivity of the acoustic sensor. To mitigate this effect, drip pan structures, illustrated in FIGS. 20 and 21 may be used to restrict airflow or seal the perforations.

FIG. 20 illustrates a process of forming drain pans for etch perforations formed in the acoustic sensor in accordance with an embodiment of the present invention. Referring to FIG. 20, an etch release hole 2010 (also shown in FIG. 2A) exists at a portion of a diaphragm 2020 of the sensor. A portion of an underlying polysilicon layer is structured as a lip 2030. Lip 2030 may restrict airflow through the etch release hole perforation 2010 or lip 2030 may be used to collect a sealant (e.g., a material applied during a sputtering, evaporation, or atomic layer deposition process step) when it is applied to the top surface the sensor.

FIG. 21 illustrates a process of sealing drain pans and etch perforations formed in the acoustic sensor in accordance with an embodiment of the present invention. Referring to FIG. 21, FIG. 21 illustrates a sealing layer 2110 deposited on the top surface of the sensor.

In further embodiments, the manufacturing process for the acoustic sensor may be limited to a purely surface micromachined construction as described above so that multiple sensors may be constructed on a single die and/or the sensors may be constructed on top of an active semiconductor device, such as a CMOS die.

The acoustic sensor of the present invention can be micromachined on silicon using in less than 1 mm² area. Compared to conventional measurement microphones, this structure is much smaller and can take advantage of the economies of scale inherent to semiconductor processing, leading to very low device unit cost. When compared to other types of MEMS microphones, this structure has a unique top-side cavity which allows surface-micromachined fabrication, which may be suitable for fabrication with post-CMOS MEMS fabrication processes and integration with a previously developed pressure gradient sensor to realize a small-size, low-cost, single chip sound intensity probe.

The present invention can be utilized in several applications, including use in aeroacoustic and automotive diagnostics and sound localization, which has applications in hearing aids, speech recognitions systems, special medical instrumentation including acoustic emission based hearing health diagnostic systems, and special instrumentation applications, such as large audio arrays.

Other variations are within the spirit of the present invention. Thus, while the present invention is susceptible to various modifications and alternative constructions, certain illustrated embodiments thereof are shown in the drawings and have been described above in detail. It should be understood, however, that there is no intention to limit the present invention to the specific form or forms disclosed, but on the contrary, the intention is to cover all modifications, alternative constructions, and equivalents falling within the spirit and scope of the present invention, as defined in the appended claims.

The use of the terms “a” and “an” and “the” and similar referents in the context of describing the present invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the present invention and does not pose a limitation on the scope of the present invention unless otherwise claimed. No language in the specification should be construed as indicating any non-claimed element as essential to the practice of the present invention.

Preferred embodiments of this present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the present invention to be practiced otherwise than as specifically described herein. Accordingly, the present invention includes all modifications and equivalents of the subject matter recited in the claims appended hereto as permitted by applicable law. Moreover, any combination of the above-described elements in all possible variations thereof is encompassed by the present invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An acoustic sensor, comprising:
a diaphragm attached to a substrate via a plurality of columns forming a cavity; and
a plurality of structures shorter in length than said plurality of columns attached to said substrate, wherein said plurality of structures is electrically conductive forming a lower electrode.

2. The acoustic sensor as recited in claim 1, wherein said cavity contains a barometric vent to an outside world.

3. An acoustic sensor, comprising:
a diaphragm attached to a substrate via a first set of sidewalls forming a first cavity;
a lower electrode attached to said substrate that is capacitively coupled to said diaphragm;
an upper electrode attached to said substrate via a second set of sidewalls, wherein said upper electrode has vents such that air pressure from sound waves deflect said diaphragm; and
a second cavity formed between said upper electrode and said diaphragm forming a second capacitively coupled structure.

4. The acoustic sensor as recited in claim 3, wherein a first bias voltage is applied between said diaphragm and said lower electrode and a second bias voltage is applied between said diaphragm and said upper electrode.

5. The acoustic sensor as recited in claim 4, wherein said first and second bias voltages are balanced such that said diaphragm is physically centered between said upper and lower electrodes.

6. The acoustic sensor as recited in claim 3, wherein said first set of sidewalls contains at least one opening forming a barometric vent.

7. An acoustic sensor, comprising:
a diaphragm attached to a substrate via a first set of sidewalls;
a lower electrode attached to said substrate via a second set of sidewalls, wherein said lower electrode is formed below said diaphragm, wherein said lower electrode has vents to a cavity formed between said lower electrode and said substrate; and
a second cavity formed between said lower electrode and said diaphragm.

8. The acoustic sensor as recited in claim 7, wherein said first set of sidewalls contains at least one opening forming a vent.

9. An acoustic sensor, comprising:
a planar diaphragm with an active area;
a cavity disposed at least partially above a substrate, wherein said cavity has a wall formed by said diaphragm, wherein said cavity has a planar area that is greater than said active area of said diaphragm; and
one or more bottom electrodes.

10. The acoustic sensor as recited in claim 9, wherein said diaphragm comprises an approximately 2 μm thick polysilicon layer, wherein said cavity comprises an approximately 11 μm tall cylindrical air volume with an approximately 504 μm radius enclosed by said approximately 2 μm thick polysilicon diaphragm layer.

11. The acoustic sensor as recited in claim 10, wherein said polysilicon diaphragm layer has a clamped boundary condition at said approximately 504 μm radius perimeter.

12. The acoustic sensor as recited in claim 10, wherein said diaphragm is attached to a plurality of post structures from a radius of approximately 315 μm to said approximately 504 μm radius to prevent a portion of said diaphragm from moving during operation.

13. The acoustic sensor as recited in claim 12, wherein in a center region of said diaphragm from a radius of approximately 0 μm to said approximately 315 μm, there exists no post structures thereby allowing said diaphragm to move freely towards and away from said one or more bottom electrodes.

14. The acoustic sensor as recited in claim 11, wherein said clamped boundary condition is affixed to a sidewall that is attached to said substrate.

15. The acoustic sensor as recited in claim 9, wherein said diaphragm is attached to a plurality of post structures preventing a portion of said diaphragm from moving during operation.

16. The acoustic sensor as recited in claim 9, wherein said diaphragm comprises a conductively doped material acting as an electrode.

17. The acoustic sensor as recited in claim 9, wherein said diaphragm comprises a layer of conductive material deposited on it to form an electrode.

18. The acoustic sensor as recited in claim 9 further comprising:
a release hole existing at a portion of said diaphragm.

19. The acoustic sensor as recited in claim 18 further comprising:
a layer of polysilicon underneath said diaphragm configured to restrict airflow through said release hole or configured to collect a sealant when it is applied to a top surface of said sensor.

20. The acoustic sensor as recited in claim 19 further comprising:
a sealing layer on said top surface of said sensor.
